(19) United States
(12) Patent Application Publication
(10) Pub. No.: US 2016/0021910 A1
(43) Pub. Date: Jan. 28, 2016

(54) Coated Chewing Gum with a Hard Caramel Layer

(71) Applicant: Müller-Vivil ALEXANDER, Offenburg (DE)

(72) Inventor: Alexander Müller-Vivil, Offenburg (DE)

(21) Appl. No.: 14/773,492

(22) PCT Filed: Mar. 6, 2014
(86) PCT No.: PCT/EP2014/054318

§ 371 Date: Sep. 8, 2015

(30) Foreign Application Priority Data
Mar. 6, 2013 (EP) 13157999

(51) Int. Cl. A23G 4/20; A23G 4/10

(52) U.S. Cl. CPC A23G 4/20; A23G 4/10; A23V 2002/00

(57) ABSTRACT

The invention relates to a chewing gum which has a chewing mass and a coating. The chewing mass contains a gum base, at least one sugar and/or at least one sugar substitute, at least one sweetener, a softening agent, and optionally a flavor, and the coating contains at least one sugar and/or at least one sugar substitute, at least one sweetener, and water. By encasing the chewing mass with a hard caramel layer which contains at least one sugar substitute, flavors which normally cannot be used in chewing gums can be used to flavor the chewing gum.

The subject matter of the invention is a preferably sugar-free chewing gum comprising a chewing mass and a coating, wherein the chewing mass comprises at least one gum base and at least one sugar and/or at least one sugar substitute, and the coating contains at least one sugar and/or at least one sugar substitute, at least one sweetener, and water.

Chewing gums of the sugar-containing and sugar-free variants have been known for a long time and enjoyed great popularity. In sugar-free chewing gums, a mixture of sugar substitutes and sweeteners is usually used for sweetening. For this purpose, the polyol based sugar substitutes that have become available most recently have proven to be particularly satisfactory.

However, the flavoring of both sugar-containing and also sugar-free chewing gums has been difficult so far, since the flavor has to be used at an extremely high dose to achieve a good resulting taste. Thus, in part the necessary amount of flavor is from 4 to 10 times higher than with other foods, in order to obtain a good flavor. Therefore, highly flavor-intensive natural flavors such as orange, lemon, peppermint and crisped mint are usually used. Alternatively, highly concentrated nature-identical flavors are used, wherein care must be taken whenever selecting the flavor to ensure that the flavor does not attack the gum base. Some flavors or an excessively high flavor dose have a negative influence on the plasticity of the gum base. Therefore, one must ensure that the flavors are released from the gum base during the chewing process. Therefore, the flavors should preferably remain in the hydrophilic phase consisting of sugar or sugar substitute in order to be released during the chewing. To achieve a good flavor already at the beginning of the chewing process, that is to say a so-called intense initial flavor, a coating with a flavor or a powder on the chewing gum surface is used.

EP 1 357 800 B1 describes a hard caramel lozenge with an intermediate layer made of chewing gum. Here, the flavor is introduced in addition to the gum base in the hard caramel layer or in a liquid filling in the core.

The disadvantages of known chewing gums thus are that a high flavor dose is necessary, that only certain flavors can be used at all, and that in many cases a mixing of flavors is not possible. When combining different flavors, said flavors can react with one another resulting in a bitter taste of the chewing gum or destruction of the flavors.

The problem of the present intention therefore is to provide a chewing gum which allows the use of different flavors in combination, the use of a low flavor dose, a good initial taste during the chewing of the chewing gum, and a consistent flavor release during the chewing process.

The problem is solved according to the invention by a preferably sugar-free chewing gum comprising a chewing mass and a coating, wherein the chewing mass contains at least one gum base and at least one sugar and/or at least one sugar substitute, and the coating contains at least one sugar and/or at least one sugar substitute, at least one sweetener and water, and preferably the chewing mass and the coating are each free of sugar, characterized in that the chewing mass is encased at least partially by a hard caramel layer, the coating is applied onto the hard caramel layer, and the hard caramel layer contains at least one sugar substitute, at least one flavor, and water, and the hard caramel layer is preferably free of sugar.

Other embodiments are the subject matter of the dependent claims or are described below.

In the sense of the invention, “sugar-free” is understood to mean free of beet or cane sugar, that is to say free of saccharose, which is added, for example, in the form of refined sugar, white sugar, semi-white sugar, liquid sugar or invert sugar to sugar-containing confectionary products.

The chewing gum according to the invention preferably contains a gelling agent, preferably the gelling agents gellan, gellan gum, gelatin, gum arabic, carob bean gum or xanthan gum, particularly preferably gellan, gellan gum, gum arabic or a mixture thereof.

Preferably, the chewing gum consists of 30 to 60% by weight, preferably 40-50% by weight of chewing mass, 20 to 50% by weight, preferably 25-35% by weight of hard caramel layer, and 10 to 35% by weight, preferably 20-30% by weight of coating. The hard caramel layer here preferably has a residual moisture of 5 to 10% by weight.

The chewing gum according to the invention can contain sugar. As sugar, glucose, saccharose, fructose, invert sugar, maltose, lactose or a mixture thereof is usually used.

The chewing gum according to the invention alternatively comprises sugar substitutes and/or sweeteners instead of or in addition to sugar. The sugar substitutes are preferably polyols, particularly preferably mannitol, sorbitol, xylitol, maltitol or maltitol syrup, lactitol, isomalt, erythritol or a mixture thereof. Particularly preferably, the chewing mass comprises a mixture of maltitol syrup, isomalt, sorbitol and/or xylitol as sugar substitutes. The hard caramel layer preferably comprises isomalt and/or maltitol syrup as sugar substitute. The coating preferably comprises isomalt, maltitol and/or sorbitol, preferably isomalt, as sugar substitute. As sweeteners, all the conventional sweeteners can be used; aspartame, acesulfame K, neotame, Stevia, Twinsweet® (aspartame-acesulfame salt), sucralose or a mixture thereof are preferably used as sweeteners.

The chewing mass preferably contains at least one gum base, preferably 25 to 35% by weight of gum base, at least one sugar substitute, preferably 50 to 70% by weight of at least one sugar substitute, at least one sweetener, at least one softener, and at least one flavoring, in each case relative to the total weight of the chewing mass. The chewing mass of the chewing gum according to the invention preferably contains

25 to 35% by weight of at least one gum base,

50 to 70% by weight of at least one sugar substitute,

0.05 to 0.2% by weight of at least one sweetener,

0.5 to 2% by weight of softener and/or humectant, and

0.01 to 5% by weight of at least one volatile and/or one powdered flavoring,

0 to 5% by weight of vitamins, trace elements, other mineral nutrients, acids, dental care substances or a mixture thereof,

wherein the components add up to 100% by weight.

The coating contains preferably 70 to 99% by weight of a sugar substitute relative to the total weight of the coating. The coating contains particularly preferably

50 to 99% by weight of at least one sugar substitute,

0.001 to 5% by weight of at least one gelling agent, preferably gellan gum arabic,

0 to 2% by weight of a pigment,

0.001 to 0.3% by weight of at least one sweetener,

0 to 5% by weight of at least one flavoring,

as well as optionally at least one glazing agent, and optionally at least one releasing agent,

and

residual water,

wherein the components add up to 100% by weight.

Particularly preferably, the coating consists of a gumming, a soft coating and a hard coating. The gumming has to create a rough surface on the hard sugar layer to which the coating can be applied more easily and on which it has a better hold.

The hard caramel layer of the chewing gum according to the invention preferably contains

50 to 95% by weight of at least one sugar substitute,

0.001 to 5% by weight of at least one gelling agent, preferably gellan or gum arabic,

0.001 to 5% by weight of at least one flavor, at least one vitamin, at least one trace element, at least one other mineral nutrient, at least one dental care substance or a mixture thereof,

optionally at least one acid,

optionally at least one sweetener,

water

wherein the components add up to 100% by weight.

The chewing mass, the coating and the hard caramel layer are preferably combined with one another in the above-mentioned compositions.

The chewing mass and the hard caramel layer preferably contain different flavors with different taste directions. Particularly preferred flavors are liquid and/or powdered flavors as well as encapsulated flavors, for example, Evercool® and Everfresh® mint flavors from Givaudan, Q. Pearl®, Pearl and Permasseal® flavors from Givaudan, Powercaps® and Physcool® flavors from Mane Fils as well as Luctadry powder flavors from Lucta.

The chewing gum according to the invention comprises a chewing mass as inner core. This chewing mass is enclosed at least partially by a hard caramel layer (hard sugar coat). Towards the outside, the chewing gum according to the invention is encased by a coating on the hard caramel layer. Preferably, the chewing mass is enclosed essentially completely by the hard caramel layer, i.e., coated with said hard caramel layer, wherein production-caused smaller cracks or gaps can be present. In the case of a spherical chewing gum, the inner spherical core consisting of chewing mass, for example, is encased by a hollow sphere in the form of the hard sugar cover, which itself is in turn encased by a coating. In the case of a flat chewing gum, correspondingly, the flat chewing mass interior, for example, is also encased by a flat hard caramel layer, or strips of the hard caramel layer are applied to the chewing mass. The coating then completely encloses the chewing mass and the hard caramel layer.

The coating is produced in an embodiment from a gumming, soft coating and a hard coating applied thereto. Depending on the desired exterior of the chewing gum, the coating preferably contains one or more pigments. Thus, for the production of a white chewing gum, for example, titanium dioxide is added to the coating. Calcium carbonate is also used for a white color. Various other pigments are conventionally used to achieve different colors:

true carmine: red,

red beet: red,

curcumin (turmeric): yellow,

β-carotene: orange,

paprika concentrate: orange,

copper chlorophyllin: green,

indigotin: blue,

plant charcoal: black.

It is also possible to use starch-based color flakes in different colors. The color flakes are applied to the last still moist coating layer.

The combination of chewing mass and hard caramel layer of the chewing gum according to the invention makes it possible to use various flavors in the chewing mass or the hard caramel layer, i.e., flavors with different taste directions in one chewing gum. As a result, it is possible to generate flavor combinations that are not possible in conventional chewing gums. On the one hand, it is possible to use flavors such as fruity and minty (mint fresh) or menthol fresh, which would react with one another in conventional chewing gums, resulting in a bitter taste. On the other hand, in the hard caramel layer, technically different flavors can be used from those used in the chewing mass in which, for reasons pertaining to process technology, only a limited selection of flavorings can be processed and thus only a limited number of taste directions can be achieved. In the hard caramel layer, it is possible to use almost all the flavors conventionally used in foods, whereas, in conventional chewing gums, only highly flavor-intensive and highly concentrated flavors can be used. As a result, on the one hand, the amount of the flavor used can be reduced and, on the other hand, taste directions can be achieved that cannot be produced in conventional chewing gums. An example of such taste directions consists of combinations of fruit and mint flavors, i.e., of fruity and cooling flavors in a chewing gum. As a result of the separate incorporation of these different flavors in two chewing gum layers—in the hard caramel layer and in the chewing mass—it is possible to produce pure mixed flavors with no bitter note.

Preferably, the hard caramel layer that surrounds the chewing mass is unexpectedly soft when chewed. When first biting into the chewing gum, the hard caramel layer does not splinter like conventional hard caramels or hard caramel layers. Instead, a hard caramel layer is achieved that is soft and crunchy to the bite. On the one hand, this is achieved according to the invention by using the gelling agent. On the other hand, the coating applied to the hard caramel layer makes it possible to preserve the residual moisture in the hard caramel layer and not to harden said hard caramel layer subsequently.

The preferably sugar-free chewing gum according to the invention thus also comprises, in addition to a special combination of flavors, also “normal” chewing characteristics, that is to say the typical chewing characteristics of a commercial chewing gum, which also contributes to the good taste.

The hard caramel layer according to the invention makes it possible to add not only flavors but also vitamins. In conventional chewing gums, many vitamins can also be incorporated, since they in part do not dissolve out of the lipophilic gum base, attack the gum base or negatively influence the taste. In the chewing gum according to the invention, in an embodiment, vitamins are added to the hard caramel layer, so that the chewing gum according to the invention additionally contains vitamins. It is preferable to add, as vitamins, vitamin C, vitamin B2, vitamin B6, vitamin B 12, vitamin E, vitamin D, vitamin A, biotin, niacin, thiamine, pantothenic acid, folic acid or mixtures thereof.

As additives, mineral substances, including trace elements, are also used optionally, for example, calcium, magnesium, zinc and/or iron.

Other suitable additives are acids. Dental care substances, for example, abrasive substances such as calcium phosphates, are also suitable additives.

### EXAMPLE

The invention is further explained in reference to the following example:

A chewing mass according to the invention, a hard caramel layer and a coating were produced, based on the following compositions:

### Chewing Mass:

| Raw material used | Further explanation | Quantity in kg |
|---|---|---|
| Gum Base Solsona T | Gum base | 15.500 |
| C*Mannidex 16705 | Mannitol; polyol | 15.500 |
| Neosorb ® P60W | Sorbitol; polyol | 15.500 |
| Xylisorb ® 90 | Xylitol; polyol | 1.500 |
| Lycasin ® 80/55 | Maltitol syrup; polyol | 3.500 |
| Glycerol Ph. Eur. III 86% | Humectant | 0.750 |
| Delios ® V | MCT oil | 0.185 |
| Aspartame | Sweetener | 0.045 |
| Sucralose | Sweetener | 0.015 |
| AsperCote 25 ELP | Sweetener | 0.015 |
| Citric acid c44-90 | Acid | 0.600 |
| Luctadry Wild Cherry | Flavor | 0.270 |
| 28366A | | |
| Wild Cherry 28445A | Flavor | 0.800 |
| Lucta Fresh 02337A | Flavor | 0.050 |
| | | in total: 54.230 kg |

The gum base was kneaded with Lycasin®, glycerol, and Delios® V. Subsequently, mannitol, sorbitol, xylitol, the sweeteners and the citric acid were added. The flavors were then mixed in and the whole preparation was kneaded to form a homogeneous chewing mass.

### Hard Caramel Layer:

| Raw material | Further explanation | Quantity in kg |
|---|---|---|
| Isomalt M | Isomalt; polyol | 60.000 |
| Isomalt PF | Isomalt; polyol | 1.340 |
| Delios ® V | MTC oil | 0.500 |
| Water | | 40.000 |
| Lycasin ® 80/55 | Maltitol syrup; polyol | 12.000 |
| Optamint ® 225977 | Flavor | 0.134 |
| Gum arabic powder | Thickener | 1.600 |
| Water | | 6.400 |
| | | in total: 121.974 kg |
| | | 97.204 kg actual |
| | | yield |

Isomalt M was predissolved in water and boiled at 110° C. The remaining ingredients were mixed with one another to form a homogeneous solution and added to the isomalt M/water mixture. The mixture was boiled to a residual water content of approximately 7% by weight.

### Coating:

| Raw material | Further explanation | Quantity in kg |
|---|---|---|
| Isomalt PF powder | Isomalt; polyol | 75.000 |
| Talc | Releasing agent | 0.500 |
| Indian menthol | Flavor | 1.800 |
| Lucta Fresh 02337 | Flavor | 0.600 |
| Optamint ® 204576 | Flavor | 1.200 |
| Quick Gloss C carnauba wax | Gloss agent | 0.600 |
| Red Flakes 108693. YN | Color flakes | 0.900 |
| Coating solution chewing gum | | 270.000 |

in total: 350.600 kg
261.491 kg actual
yield

### Coating Solution Chewing Gum

| Raw material | Further explanation | Quantity in kg |
|---|---|---|
| Water | | 86.568 |
| Isomalt GS powder | Isomalt; polyol | 175.479 |
| Gum arabic | Thickener | 6.036 |
| Titanium dioxide | White pigment | 1.346 |
| Kronos ® 1171 | | |
| Aspartame | Sweetener | 0.162 |
| Acesulfame K | Sweetener | 0.409 |
| | | in total: 270.000 kg |

The coating solution was prepared by heating the isomalt GS with water to approximately 80° C. Subsequently, the remaining ingredients were added. The whole preparation was boiled to form a homogeneous mass. The temperature of the coating solution was adjusted to 60° C. for further use.

For the preparation of the chewing gum, chewing mass and hard caramel layer were combined in a coextruder, so that the hard caramel layer in the end surrounded the chewing mass. This mass was equalized, i.e., shaped to form a strand, and it was shaped in the molding set to form chewing gum cores, blanks without coating. These chewing gum blanks were then cooled in the cooling tunnel, before the coating was applied.

First, two coating layers were applied to the chewing gum blanks and then they were sprinkled in each case with isomalt PF powder until the blanks were dry. Subsequently, two additional coating layers were applied to the chewing gum blanks, which were no longer sprinkled with isomalt PF powder but instead rolled around in each case with hot air in the coating vessel until the coating solution had evaporated completely and the chewing gum blanks were dried. Towards the end of the coating, the flavors were added to the coating solution in order to achieve the freshness effect when biting into the chewing gum. As for the last coating layers, shortly before the complete drying of the chewing gum blanks, the color flakes were applied additionally. Finally, the chewing gum blanks were made glossy with carnauba wax that had been mixed with talc for an improved, more consistent distribution, i.e., powdered carnauba wax was added to the coated chewing gum blanks; the gloss developed gradually by rolling the individual chewing gums in the coating vessel.

A large portion of the aqueous solution—added water but also residual moisture of the other additives used—evaporated during this process. The residual water content of the coating after drying was 2.5% by weight.

The proportion of the chewing mass in the total product is approximately 28% by weight, the proportion of the hard caramel layer is approximately 42% by weight, and the proportion of the coating is approximately 30% by weight.

The chewing gum exhibits good chewing characteristics and it has a fruity-fresh taste of wild cherry and at the same time mint, i.e., a mint fresh taste.

1. Chewing gum comprising a chewing mass and a coating, wherein
the chewing mass contains at least a) one gum base and b) at least one sugar and/or at least one sugar substitute, and
the coating contains at least one sugar and/or at least one sugar substitute, at least one sweetener, and water,
characterized in that the chewing mass is encased at least partially by a hard caramel layer, the coating is applied onto the hard caramel layer, and the hard caramel layer contains at least one sugar substitute, at least one flavor, and water, and the hard caramel layer is preferably free of sugar.

2. Chewing gum according to claim 1, characterized in that the hard caramel layer contains at least one gelling agent.

3. Chewing gum according to claim 2, characterized in that the gelling agent is gellan, gellan gum, gelatin, gum arabic, carob bean gum, xanthan gum, preferably gellan, gellan gum and/or gum arabic.

4. Chewing gum according to claim 3, characterized in that the chewing gum is free of sugar.

5. Chewing gum according to claim 4, characterized in that the chewing mass contains 25 to 35% by weight of gum base, 50 to 70% by weight of sugar substitute, at least one sweetener, at least one softener and/or humectant and at least one flavoring, in each case relative to the total weight of the chewing mass.

6. Chewing gum according to claim 5, characterized in that the coating contains 70 to 99% by weight of at least one sugar substitute relative to the total weight of the coating.

7. Chewing gum according to according to claim 6, characterized in that the chewing gum contains 30 to 60% by weight of chewing mass, 20 to 50% by weight of hard caramel layer, and 10 to 35% by weight of coating, wherein the components add up to 100% by weight.

8. Chewing gum according to claim 7, characterized in that the sugar substitutes are preferably polyols, particularly preferably mannitol, sorbitol, xylitol, maltitol, maltitol syrup, lactitol, isomalt, erythritol or a mixture thereof.

9. Chewing gum according to claim 8, characterized in that the chewing mass contains a mixture of maltitol syrup, isomalt, sorbitol, sucralose, xylitol or a mixture thereof as sugar substitutes and/or the hard caramel layer contains isomalt and/or maltitol syrup as sugar substitute and/or the coating contains isomalt as sugar substitute.

10. Chewing gum according to claim 9, characterized in that the residual moisture of the hard caramel layer is 1 to 10% by weight by weight.

11. Chewing gum according to claim 10, characterized in that the chewing mass is encased completely by the hard caramel layer.

12. Chewing gum according to claim 11, characterized in that the chewing mass contains
25 to 35% by weight of at least one gum base,
50 to 70% by weight of at least one sugar substitute,
0.05 to 0.2% by weight of at least one sweetener,
0.5 to 2% by weight of softener and/or humectant, and
0.01 to 5% by weight of at least one volatile and/or powdered flavoring,
0 to 5% by weight of vitamins, trace elements, other mineral nutrients, acids, dental care substances or a mixture thereof,
wherein the components add up to 100% by weight.

13. Chewing gum according to claim 12, characterized in that the coating consists of a gumming, a soft coating, and a hard coating.

14. Chewing gum according to claim 13, characterized in that the coating contains
70 to 99% by weight of at least one sugar substitute,
0.001 to 5% by weight of at least one gelling agent, preferably wherein the gelling agent is gum arabic,
0 to 2% by weight of a pigment,
0.001 to 0.3% by weight of at least one sweetener,
0 to 5% by weight of at least one flavoring,
as well as optionally at least one glazing agent, and optionally at least one releasing agent,
and
residual water,
wherein the components add up to 100% by weight.

15. Chewing gum according to claim 14, characterized in that the hard caramel layer contains
50 to 95% by weight of at least one sugar substitute,
0.001 to 5% by weight of at least one gelling agent, wherein the gelling agent is one of gellan or gum arabic,
0.001 to 5% by weight of at least one flavor, at least one vitamin, at least one trace element, at least one other mineral nutrient, at least one dental care substance or a mixture thereof,
optionally at least one acid,
optionally at least one sweetener,
water,
wherein the components add up to 100% by weight.

16. Chewing gum according to claim 15, characterized in that the chewing mass and the hard caramel layer contain different flavors in different taste directions.

17. Chewing gum according to claim 7, characterized in that the chewing gum contains 40 to 50% by weight of chewing mass, 25 to 35% by weight of hard caramel layer, and 20 to 30% by weight of coating, wherein the components add up to 100% by weight.

18. Chewing gum according to claim 1, characterized in that the coating contains
50 to 99% by weight of at least one sugar substitute,
0.001 to 5% by weight of at least one gelling agent,
0 to 2% by weight of a pigment,
0.001 to 0.3% by weight of at least one sweetener,
0 to 5% by weight of at least one flavoring,
as well as optionally at least one glazing agent, and optionally at least one releasing agent,
and
residual water,
wherein the components add up to 100% by weight.

19. Chewing gum according to claim 2, characterized in that the hard caramel layer contains
50 to 95% by weight of at least one sugar substitute,
0.001 to 5% by weight of at least one gelling agent,
0.001 to 5% by weight of at least one flavor, at least one vitamin, at least one trace element, at least one other mineral nutrient, at least one dental care substance or a mixture thereof,
optionally at least one acid,
optionally at least one sweetener,
water,
wherein the components add up to 100% by weight.

20. Chewing gum according to claim 10, characterized in that the residual moisture of the hard caramel layer is 5 to 10% by weight by weight.
